(19) United States
(12) Patent Application Publication
(10) Pub. No.: US 2024/0252856 A1
(43) Pub. Date: Aug. 1, 2024

(54) TORCH DEVICE HAVING A DETACHABLE ELECTRIC BOOM ARM

(71) Applicant: Carl Counti, Kansas City, MO (US)

(72) Inventor: Carl Counti, Kansas City, MO (US)

(21) Appl. No.: 18/427,417

(22) Filed: Jan. 30, 2024

Related U.S. Application Data
(60) Provisional application No. 63/482,104, filed on Jan. 30, 2023.

(51) Int. Cl. A62C 3/02; F23K 5/04; F23Q 2/02; F23Q 3/00

(52) U.S. Cl. CPC A62C 3/0285; F23Q 2/02; F23K 5/04; F23Q 3/008

(57) ABSTRACT

A torch device includes an arm operatively coupled to a supply line that is electrically coupled to a power supply and in flow communication with a fuel tank. A distal end of the arm includes a nozzle positioned adjacent to a fuel ignition system. A mount removably couples the arm to the torch device, such that the arm is configured to be used in a first use position that includes the arm removably coupled to the mount and in a second use position that includes the arm removed from the mount. The supply line is secured to a first end of the arm, extends through the arm, and has a length such that the arm can be used in the second use position up to a distance from the fuel tank approximately equivalent to the length of the supply line.

### CROSS-REFERENCE TO RELATED APPLICATION

This application claims the benefit of U.S. Provisional Patent Application No. 63/482,104 filed Jan. 30, 2023, the disclosure of which is incorporated by reference herein.

### BACKGROUND OF THE INVENTION

### Field of the Invention

The present invention relates to a torch device, and more particularly to a drip torch having a detachable electric arm.

### Background and Related Art

A drip torch is a device configured to drip ignited fuel and is used for controlled burns, wildfire suppression and other forestry applications. Various solutions have been proposed for devices to ignite prescribed fires. US Patent Application Publication No. 20210278177 to Clanton et al. describes a portable electric flamethrower that includes a fuel supply that may be carried by a user, the fuel supply in flow communication with a pump mounted on the flamethrower. US Patent Application Publication No. 20210318104 to Gore describes a portable, spark ignition flamethrower that ignites a fuel supply using a spark generated by electrodes.

The United States Department of Agriculture has developed a utility terrain vehicle (UTV) torch designed to mount in a rear cargo area of a UTV. The vehicle mounted torch includes an igniter arm coupled to a fuel tank that projects and ignites fuel. If a user desires to approach a location on foot that may not be approachable with the vehicle, the user must at least disconnect the fuel supply in flow communication with the igniter arm and connect a handheld wand to the fuel supply.

### BRIEF SUMMARY OF THE INVENTION

The embodiments described herein relate to a torch device configured to electrically generate a spark to ignite a stream of fuel and includes an arm secured to a supply line. The supply line includes a fuel line that is in flow communication with a fuel tank and electrical conductors that are electrically coupled to a power supply. The arm is removably couplable to a mount of the torch device, and the supply line has a length such that a user can uncouple the arm from the mount, the supply line remaining connected to the arm, move the arm a distance from the fuel tank up to a distance approximately equivalent to a length of the supply line, and actuate the arm.

The arm of the torch device is operatively coupled to the supply line. The supply line is secured to the arm in a first use position that includes the arm removably coupled to the mount and in a second use position that includes the arm removed from the mount. The supply line is secured to a first end of the arm and extends through the arm. A distal end of the arm includes a nozzle positioned adjacent to a fuel ignition system. The nozzle is in flow communication with the fuel tank via the supply line, and the fuel ignition system in electrical communication with the power supply via the supply line. In an embodiment, a control valve is configured to adjustably control a flow of fuel through the supply line to the nozzle.

In an embodiment the arm includes a first leg and a second leg, which may be an upper leg and a lower leg connected in spaced relation. In an embodiment, the first leg is removably couplable to the mount. In an embodiment, the supply line is secured to a first end of the second leg of the arm and extends through the second leg to a distal end of the arm.

The mount includes a connector that is rotatably mounted to the fuel tank and removably couples the arm thereto and a locking assembly that secures the connector to fix a rotational position thereof. In embodiment, the connector of the mount projects outward from the fuel tank and is slidably fitable within a first end of the first leg of the arm to removably couple the first leg of the arm thereto. In an embodiment, the arm may be secured to the connector by a pin insertable through aligned apertures in a distal portion of the connector and the first end of the first leg of the arm.

The fuel ignition system is selectively connectable to the power supply by engagement of a first switch when the arm is in the first use position and a second switch when the arm is in the second use position. The first switch is also engageable to electrically connect the power supply to a fuel pump in flow communication with the fuel tank and the nozzle. A hand grip, extending from at least the second leg, may include the second switch that is engageable when the arm is in the second use position to selectively connect the fuel ignition system with the power supply.

### BRIEF DESCRIPTION OF THE SEVERAL VIEWS OF THE DRAWING

FIG. 1 is a front, side perspective view of a drip torch device with a detachable electric boom arm removably coupled thereto.

FIG. 2 is a top plan view of the drip torch device with the detachable electric boom arm as shown in FIG. 1.

FIG. 3 is a rear perspective view of the drip torch device with the detachable electric boom arm as shown in FIG. 1.

FIG. 4 is a front perspective view of the detachable electric boom arm shown in FIG. 1, uncoupled from a mount of the drip torch device and with a supply line secured to the detachable electric boom arm.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein

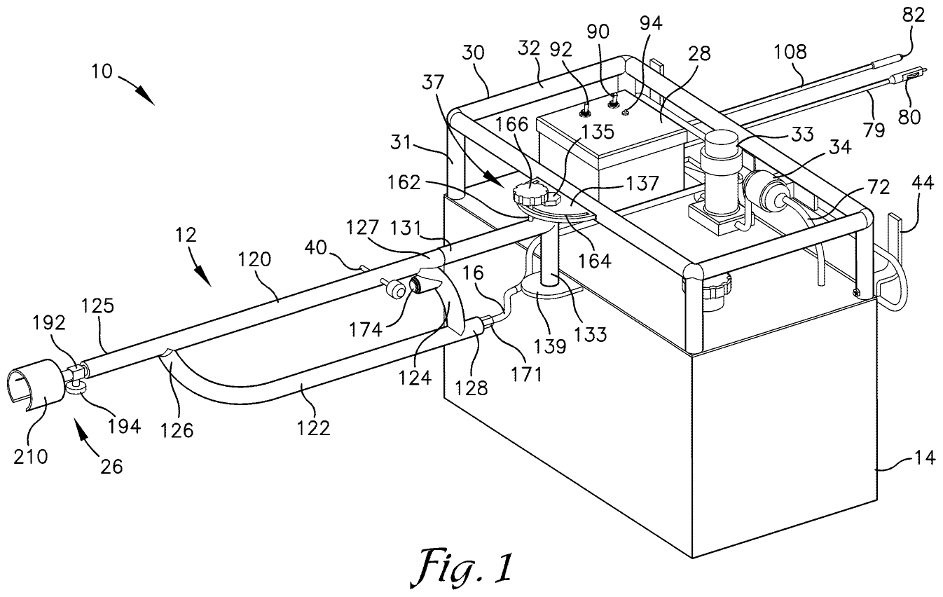

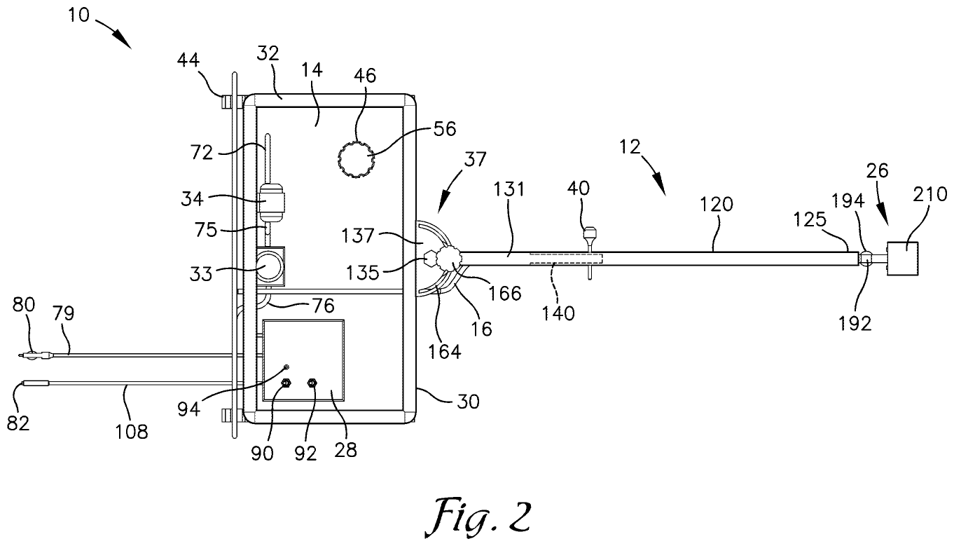

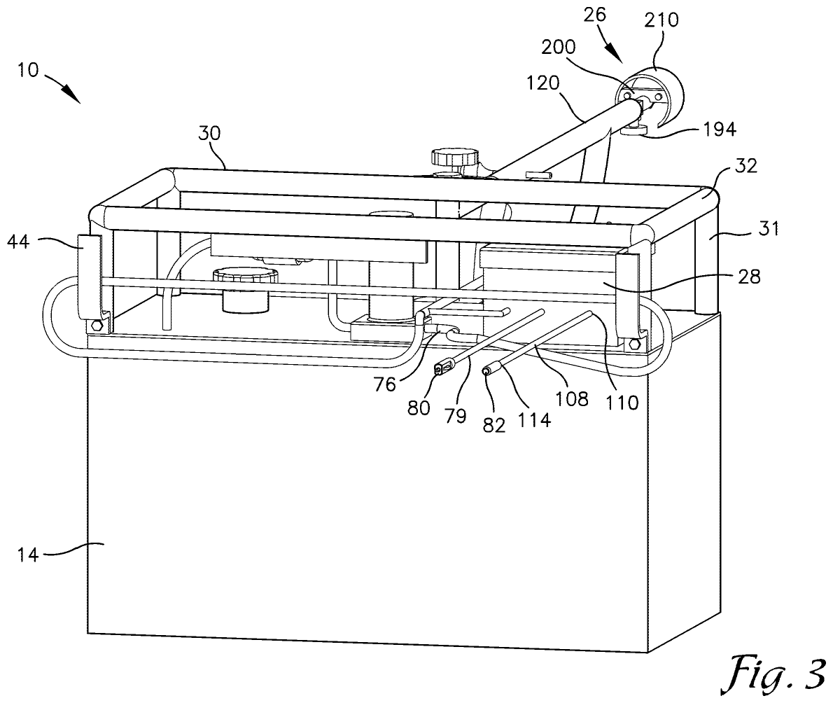

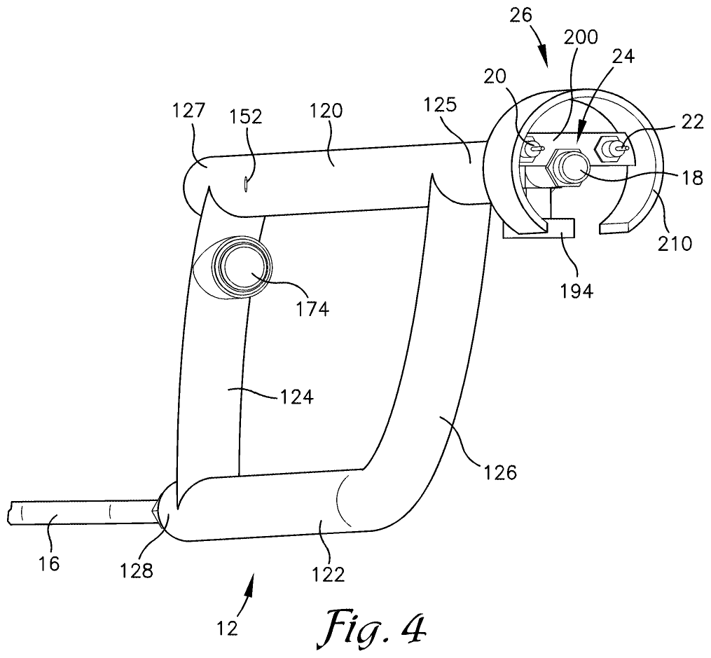

Embodiments disclosed herein describe a vehicle mounted drip torch device 10, as shown in FIGS. 1-4, having a detachable boom arm or wand 12 flow connected to a fuel tank 14 by a flexible, power and fuel supply line or main line 16. The boom arm 12 is coupled to the fuel tank 14 and configured to project outward therefrom. As best shown in FIG. 4, a nozzle 18 and first and second electrodes 20 and 22 of a fuel ignition system 24 are mounted on a second or distal end 26 of the boom arm 12. The electrodes 20 and 22 are positioned adjacent the nozzle 18 and configured to generate a spark to ignite a stream of fuel supplied to the nozzle 18 from the fuel tank 14 through the fuel supply line 16. The electrodes 20 and 22 are electrically connected to a power supply (not shown) through a control box 28 by electrical or power supply conductors (not shown) connected to and running along or through the power and fuel supply line 16. The fuel tank 14 of the drip torch device 10 is adapted to be secured within or mounted to a surface of a vehicle, such as a bed or cargo area of a truck or a utility terrain vehicle (not shown). A rail assembly or component enclosure 30 is mounted on or secured to an upper surface of the fuel tank and is formed from vertical rails 31 and side rails 32. The rail assembly 30 encloses and protects functional components mounted on top of the fuel tank 14 including the control box 28, a fuel pump 33 and a fuel filter 34.

The boom arm 12 is detachably connected to a pivot mount 37 mounted on the fuel tank 14 and the rail assembly 30. The boom arm 12 is operable either when pivotally connected to the fuel tank 14 by the pivot mount 37, including by a user in a cab of the vehicle, or when detached from the fuel tank 14 and held by a user a distance away from the vehicle. In one embodiment, the flexible, the power and fuel supply line 16 includes a line that conveys fuel and carries conductors for supplying electrical power to the boom arm 12. The boom arm 12 can be disconnected from the fuel tank 14 by removing a pin 40 securing the boom arm 12 to the pivot mount 37 and uncoupling the boom arm 12 from the pivot mount 37. The flexible, power and fuel supply line 16 remains connected to the boom arm 12 when the boom arm 12 is disconnected from the pivot mount 37 on the fuel tank 14. When the boom arm 12 is secured to the pivot mount 37, the flexible, power and fuel supply line 16 may be wrapped or coiled around storage hooks 44 connected to the rail assembly 30 or stored near the fuel tank 14. In a preferred embodiment, the power and fuel supply line 16 is at least fire resistant and chemically resistant. In one embodiment the power and fuel supply line 16 is a polytetrafluoroethylene-lined, braided, stainless-steel hose. When the boom arm 12 is disconnected from the pivot mount 37, the power and fuel supply line 16 is uncoiled or extended to allow a user to walk away from and separate the boom arm 12 from the fuel tank 14 up to a distance limited by the length of the power and fuel supply line 16.

In the embodiment shown, the fuel tank 14 is configured to contain fuel and is formed from a material that is at least durable, heat resistant, corrosion resistant and rust resistant. The materials from which the fuel tank 14 may be formed include stainless steel and aluminum. In one embodiment, the fuel tank 14 is formed from ⅛-inch stainless steel sheeting. It is foreseeable that the fuel tank 14 may be formed in any shape with a flat bottom surface to rest in the bed or cargo area of the vehicle. The vertical rails 31 forming the rail assembly or component enclosure 30 project upward from an upper surface of the fuel tank 14 and protect the fuel filter 34, the fuel pump 33 and the control box 28 from damage, such as damage caused by the vehicle rolling over, an object falling into the vehicle, or the fuel tank 14 falling from the vehicle. In the embodiment shown, the fuel tank 14 has a flat or level top surface, the vertical rails 31 extend upward from corners of the top surface and the side rails 32 are connected to and extend between the vertical rails 31.

The fuel tank 14 includes a fuel fill inlet 46 where fuel is poured or directed into the fuel tank 14 to be supplied to the drip torch device 10. In one embodiment, a fuel cap 56 configured to cover the fuel fill inlet 46 includes a high temperature fusible link (not shown) to reduce a likelihood of an explosion in an emergency situation. When exposed to excessive heat, the fusible link melts to allow a release of air and/or fuel vapor and to decrease pressure inside the fuel tank 14. A fuel tank vent (not shown) may be incorporated in the fuel cap 56 or separately coupled to a vent hole (not shown) in the fuel tank 14. The fuel tank vent allows air to enter the fuel tank 14 preventing a vacuum inside the tank and allows air and/or fuel vapor to exit preventing pressure build up inside the tank. In one embodiment, the fuel tank vent includes a flame arrester (not shown) to extinguish and/or prevent transmission of a flame from inside the fuel tank 14.

The fuel pump 33 draws fuel from the fuel tank 14 through an outlet fuel tank line 72, through the fuel filter 34, and through the fuel filter discharge line 75. The fuel filter 34 is a permeable filter configured to remove impurities from entering the fuel pump 33 and boom arm 12. The fuel pump 33 pushes or pumps the fuel through a fuel line 76 and through the boom arm 12. The power and fuel supply line 16 includes the fuel line 76, which may extend therein. The size and type of the fuel pump 33 is dependent on a flow rate required by applications of the drip torch device 10 and a type of fuel utilized therein. At least one control valve or fuel pressure regulator may be positioned after the fuel pump 33 to control the amount and the pressure of the fuel being supplied to the boom arm 12. In one embodiment the fuel pump 33 is a mechanical fuel pump flow connected to the fuel tank 14 and the boom arm 12. The fuel pump 33 may be powered by conductors extending from the control box 28 which may be electrically connected to a power supply cord 79 connected to and extending from the control box 28. The power supply cord 79 includes a connector or plug 80 for connecting to a power supply, including one or more of a vehicle battery, a 12V power outlet, and/or a separate or other power supply known by one skilled in the art.

The control box 28 includes electrical components known in the art necessary to supply electrical power to the fuel pump 33 and the ignition system 24 on the boom arm 12. A first power switch or toggle switch 90 electrically connects the fuel pump 33 to the power supply via the control box 28 and a second power switch or toggle switch 92 electrically connects the ignition system 24 to the power supply via the control box 28. In one embodiment the control box 28 includes an indicator light 94. The indicator light 94 may indicate whether the drip torch device 10 is electrically connected to the power supply.

In one embodiment, a first safety switch 82, electrically coupled to the control box 28 by a safety switch cord 108, may be engaged by a user to selectively connect or disconnect, via the control box 28, the electrical connection from the power supply to the fuel pump 33 and to the ignition system 24. A first end 110 of a safety switch cord 108 is electrically connected to the control box 28 and the safety switch 82 is connected to a second end 114 of the safety switch cord 108. The safety switch cord 108 is preferably long enough to extend to a user, including a user sitting in a cab of the vehicle on which the drip torch device 10 is mounted. In the embodiment shown, engagement of the three switches, including the first power switch 90, the second power switch 92 and the first safety switch 82, actuates the drip torch device 10, igniting a fuel stream exiting the boom arm 12 and directing a flame. In the embodiment shown, engagement of the first power switch 90 and the safety switch 82 actuates the drip torch device 10 to pump a fuel stream from the boom arm 12, without igniting the fuel stream. The first safety switch 82 enables the user to actuate the drip torch device 10 from inside the vehicle and while operating the vehicle.

In the embodiment shown, the detachable boom arm 12 includes an upper leg 120 removably couplable to the pivot mount 37, a lower leg 122 through which the power and fuel supply line 16, which includes the fuel line 76 and electrical conductors, is routed, and a rear hand grip 124 extending between the upper leg 120 and lower leg 122 to provide a handle to be gripped by a user when using the boom arm 12 as a wand detached from the pivot mount 37. The lower leg 122 is connected to the upper leg 120 in relatively closely spaced relation rearward from a distal end or nose portion 125 of the upper leg 120 and curves downward and then rearward therefrom in generally parallel relation to the upper leg 120. The downwardly curved portion of the lower leg 122 forms a front hand grip 126 which can be gripped by a user. The rear hand grip 124 is positioned proximate rear or inner ends 127 and 128 of the upper and lower legs 120 and 122 respectively. As used herein, directional references for the components of the boom arm 12 are with reference to the boom arm 12 as shown in FIG. 1 with the upper leg 120 positioned above the lower leg 122 and the end of the boom arm 12 to which the nozzle 18 is mounted constituting the distal or front end 125 and the opposite end constituting the inner or rear ends 127 and 128.

In the embodiment shown, the upper leg 120 of the boom arm 12 is removably coupled to the pivot mount 37 joined to the fuel tank 14. The pivot mount 37 includes a boom arm connector 131 joined to and projecting outward and transverse to a bearing sleeve 133 rotatably mounted on a pin 135 supported between an upper support flange 137 mounted on one of the side rails 32 and a lower support flange 139 connected to the fuel tank 14

In the embodiment shown, the upper and lower legs 120 and 122 of the boom arm 12 are formed from rigid, hollow tubing. The boom arm connector 131 which extends outward or away from the fuel tank 14 and at least a distal portion 140 thereof has an outer diameter that is just smaller than an inner diameter of the upper leg 120 of the boom arm 12. The distal portion 140 of the boom arm connector 131 functions as a male connector and is configured to slidably fit within the hollow inner or rear female end 127 of the upper leg 120 of the boom arm 12. When the distal portion male end 140 of the boom arm connector 131 is fully inserted into the rear female end 127 of the horizontal, upper leg 120, apertures (not shown) formed in the distal portion male end 140 align with apertures 152 formed in the rear female end 127. Pin 40 inserted through the aligned apertures, including the apertures 152, secures the boom arm 12 to the boom arm connector 131. The boom arm 12 is removeable from the pivot mount 37 of the fuel tank 14 by pulling or removing the pin 40 from the apertures 152 and sliding the rear female end 127 of the upper leg 120 off of the distal portion male end 140 of the boom arm connector 131. It is foreseeably that other means for locking or securing the boom arm 12 to the boom arm connector 131 could be used, including a detent, a locking button or another mechanical device.

A locking assembly is connected to the boom arm connector 131 and operable to fix the rotational position of the boom arm connector 131 and attached boom arm 12 relative to the upper and lower support flanges 137 and 139. The locking assembly includes a post 162 which is joined to the boom arm connector 131 and extends upward through a semicircular guide slot 164 formed in the upper support flange 137. The guide slot 164 is spaced inward from an outer edge of the upper support flange 137 and the post 162 moves along the guide slot 164 as the boom arm connector 131 and attached boom arm 12 are rotated about the pivot pin supported between upper and lower flanges 137 and 139. An upper portion of the post 162 is threaded and a downwardly oriented conical wedge (not shown) is threaded onto the threaded portion of the post 162 with an upper, wider portion of the conical wedge extending above the upper flange 137 and a lower, narrower portion of the conical wedge extending into the slot 164. A knob 166 is connected to or threadingly coupled to the upper threaded portion of the post 162 just above the conical wedge. Rotating the knob 166 in one direction advances the knob downward on post 162 driving the wedge further into the slot 164 such that frictional engagement of the upper flange 137 by the wedge in the slot 164 restrains the boom arm connector 131 from being pivoted relative to the flanges 137 and 139. Rotating the knob 166 in the opposite direction releases the downward force applied to the wedge, reducing the resistance to pivoting of the boom arm connector 131 relative to the mounting flanges 137 and 139 and allowing the boom arm connector 131 to rotate. It is foreseeable that various solutions could be used to fix the rotational position of the boom arm connector 131 relative to the pivot mount 37.

In the embodiment shown, the power and fuel supply line 16, with the fuel line 76 and the power supply conductors extending therein, extend through a hollow fastener or fitting 171 secured to a first end of the lower leg 122 of the boom arm 12. The fitting 171 secures or locks the fuel supply line 16 to the first end of the lower leg 122 such that the fuel supply line 16 cannot be unintentionally pulled out of or removed from the boom arm 12. In one embodiment, the fuel supply line 16 extending between the boom arm 12 and the fuel tank 14 is of a sufficient length that a user can detach the boom arm 12 and walk away from the fuel tank 14 secured to the vehicle. In one embodiment the fuel supply line 16 may, for example, be at least 25 feet or at least 50 feet or at least 100 feet long.

A second safety switch 174 is mounted on the rear hand grip 124 of the boom arm 12 and electrically connects, via the control box 28, the power supply to the fuel pump 33 and the ignition system 24. The second safety switch 174 functions similarly to the first safety switch 82 and is used alternatively, or instead of, the first safety switch 82, when the boom arm 12 is disconnected from the pivot mount 37 and held by a user. The second safety switch 174 is selectively engaged by a user, in addition to the first and/or the second power switches 90 and 92, to electronically connect the power supply to the respective fuel pump 33 and/or the ignition system 24, actuating the drip torch device 10. In the embodiment shown, the second safety switch 174 is ergonomically positioned, similar to a trigger mechanism on a firearm, such that a user can hold and aim the boom arm 12 while simultaneously engaging the second safety switch 174. In one embodiment, the second safety switch 174 is a push-button type of switch.

The power and fuel supply line 16 extends through the lower leg 122 to a second end of the lower leg 122 and then through the distal end or nose portion 125 of the upper leg 120. The power and fuel supply line 16 is connected to a flow control valve 192 connected on one end to a distal end of the power and fuel supply line 16 and on an opposite end to the nozzle 18. The power supply conductors extending through the power and fuel supply line 16 are electrically connected to the second safety switch 174 in the rear hand grip 124 and to the electrodes 20 and 22 of the ignition system 24 and engageable by the second safety switch 174 in the rear hand grip 124 or the first safety switch 82 at the end of the safety switch cord 108 when the second power switch 92 is in engagement. A knob 194 extends from the flow control valve 192 for adjusting the fuel flow regulated by the flow control valve 192. Pump 33 is electrically connected to the power source and the control box 28. Operation of the pump 33 through the control box 28 pumps fuel from the fuel tank 14, through the fuel line 76 extending through the power and fuel supply line 16 and through the valve 193, to the nozzle 18 at the second end 26 of the upper leg 120 of the boom arm or wand 12 and into the atmosphere. The electric ignition system 24 generates a spark between electrodes 20 and 22 which ignites the fuel sprayed or dripped out of nozzle 18.

The first electrode 20 and the second electrode 22 are secured to and extend outward from a mounting bar 200, and the mounting bar 200 is connected transversely near the second end 26 of the boom arm 12. The first electrode 20 is positioned slightly above and to one side of the nozzle 18 and the second electrode 22 is positioned slightly above and to an opposite side of the nozzle 18, such that the nozzle 18 is positioned therebetween and slightly lower than the electrodes 20 and 22. The ends of the electrodes 20 and 22 are positioned slightly in front of the nozzle 18, extending toward each other. The ends of the electrodes 20 and 22 are spaced apart a distance such that when the electrodes 20 and 22 are actuated, an electric arc extends between the electrodes 20 and 22 and has a voltage that is able to ignite the fuel stream exiting the nozzle 18. The nozzle 18 is positioned such that the electric arc extending between the electrodes 20 and 22 ignites the exiting fuel stream, but the fuel stream does not interfere with and is not directed through the electric arc. The electrical components, including the electrodes 20 and 22, the power supply conductors, the electrical components in the control box 28 and the power supply cord 79, are insulated to prevent electrical current from flowing to other parts of the drip torch device 10.

The ignition system 24 includes a shield 210 joined to the mounting bar 200. The shield 210 shields the ignition system 24 of the second end 26 of the boom arm 12, preventing damage to the ignition system 24 and containing the flame. In the embodiment shown, the shield 210 has a semicircular shape and is open at the bottom such that the exiting fuel stream drips downward from the nozzle 18 and does not pool in the shield. It is foreseeable that the shield 210 could be of any shape to prevent damage to the ignition system 24 and/or to prevent injury to a user.

The drip torch device 10 uses one or a combination of carbon-based fuels depending on the application, including liquid fuels such as diesel and gasoline or gaseous fuels such as propane.

Having thus described the invention, what is claimed as new and desired to be secured by Letters Patent is as follows:

1. A torch device configured to electrically generate a spark to ignite a stream of fuel, the torch device comprising:
a supply line electrically coupled to a power supply and in flow communication with a fuel tank;
an arm operatively coupled to the supply line, wherein a distal end of the arm includes a nozzle positioned adjacent a fuel ignition system, the nozzle in flow communication with the fuel tank, and the fuel ignition system in electrical communication with the power supply; and
a mount for removably coupling the arm to the torch device,
wherein the arm is configured to be used in a first use position that includes the arm removably coupled to the mount and in a second use position that includes the arm removed from the mount, and
the supply line is secured to a first end of the arm, extends through the arm, and has a length such that the arm can be used in the second use position up to a distance from the fuel tank approximately equivalent to the length of the supply line.

2. The torch device of claim 1, wherein the arm includes a first leg and a second leg.

3. The torch device of claim 2, wherein the first leg is removably couplable to the mount.

4. The torch device of claim 2, wherein the supply line is secured to the first end of the second leg of the arm and extends through the second leg.

5. The torch device of claim 4, wherein the arm includes a hand grip extending from at least the second leg, and a switch on the hand grip is engageable when the arm is in the second use position to selectively connect the fuel ignition system with the power supply.

6. The torch device of claim 1, wherein the mount includes a connector that is rotatable and removably couples the arm thereto and a locking assembly that secures the connector to fix a rotational position thereof.

7. The torch device of claim 1, wherein the fuel ignition system is selectively connectable to the power supply by engagement of a first switch when the arm is in the first use position and a second switch when the arm is in the second use position.

8. The torch device of claim 7, wherein the first switch is engageable to electrically connect the power supply to a fuel pump in flow communication between the fuel tank and the nozzle.

9. The torch device of claim 1, wherein the supply line is secured to the arm in the first use position and in the second use position.

10. The torch device of claim 1, further comprising a control valve configured to adjustably control a flow of fuel through the supply line to the nozzle.

11. A torch device configured to electrically generate a spark to ignite a stream of fuel, the torch device comprising:
an arm that includes an upper leg and a lower leg connected in spaced relation;
a mount for removably coupling the upper leg of the arm thereto; and
a supply line operatively coupled to and extending through the lower leg to a distal end of the arm that includes a nozzle positioned adjacent a fuel ignition system, the nozzle in flow communication with a fuel tank, and the fuel ignition system in electrical communication with a power supply.

12. The torch device of claim 11, wherein the supply line is electrically coupled to the power supply and in flow communication with the fuel tank.

13. The torch device of claim 11, wherein the upper leg of the arm is removably couplable to the mount, and the supply line is secured to the lower leg of the arm in a first use position that includes the arm removably coupled to the mount and in a second use position that includes the arm removed from the mount.

14. The torch device of claim 13, wherein the arm includes a hand grip extending from at least the lower leg, and a switch on the hand grip is engageable when the arm is in the second use position to selectively connect the fuel ignition system with the power supply.

15. The torch device of claim 11, wherein the mount is rotatable and includes a locking assembly that secures the mount to fix a rotational position thereof.

16. The torch device of claim 11, wherein the fuel ignition system is selectively connectable to the power supply by engagement of one or more switches positioned therebetween.

17. The torch device of claim 16, wherein the one or more switches are engageable to electrically connect the power supply to a fuel pump in flow communication between the fuel tank and the nozzle.

18. A torch device configured to electrically generate a spark to ignite a stream of fuel, the torch device comprising:
a supply line electrically coupled to a power supply and in flow communication with a fuel tank;
an arm operatively coupled to the supply line, wherein a distal end of the arm includes a nozzle positioned adjacent a fuel ignition system, the nozzle in flow communication with the fuel tank, and the fuel ignition system in electrical communication with the power supply; and
a mount that includes a connector for removably coupling the arm to the torch device,
wherein the supply line is secured to a first end of the arm and extends through the arm,
a control valve is configured to adjustably control a flow of fuel through the supply line to the nozzle,
the supply line is secured to the arm in a first use position that includes the arm removably coupled to the mount and in a second use position that includes the arm removed from the mount,
the fuel ignition system is selectively connectable to the power supply by engagement of a first switch when the arm is in the first use position and a second switch when the arm is in the second use position, and
the first switch is engageable to electrically connect the power supply to a fuel pump in flow communication between the fuel tank and the nozzle.

19. The torch device of claim 18, wherein the arm includes a first leg and a second leg, the first leg is removably couplable to the mount, and the supply line is secured to the first end of the second leg of the arm and extends through the second leg.

20. The torch device of claim 18, wherein the connector is rotatable, and a locking assembly secures the connector to fix a rotational position thereof.
